(19) United States
(12) Patent Application Publication
(10) Pub. No.: US 2025/0058396 A1
(43) Pub. Date: Feb. 20, 2025

(54) WORK SYSTEM AND WORK METHOD

(71) Applicant: LINKWIZ INCORPORATED, Hamamatsu-shi, Shizuoka (JP)

(72) Inventors: Akihide KATO, Hamamatsu-shi, Shizuoka (JP); Motofumi SUZUKI, Hamamatsu-shi, Shizuoka (JP)

(21) Appl. No.: 18/726,748

(22) PCT Filed: Jan. 20, 2023
(86) PCT No.: PCT/JP2023/001773

§ 371 Date: Jul. 3, 2024

(30) Foreign Application Priority Data
Jan. 24, 2022 (JP) 2022-008645

(51) Int. Cl. B23K 9/095

(52) U.S. Cl. CPC B23K 9/0953; B23K 9/0956

(57) ABSTRACT

The accuracy of work prevented from deteriorating even when an error occurs between an ideal shape of a member to be processed and an actual shape thereof. The present invention relates to a work system configured to perform work for welding or joining a plurality of target members to each other, in which the work system includes a gap measurement unit configured to measure a size of a gap that occurs between the target members, and the work system is further configured to change at least one of a position of a work nozzle and an angle of the work nozzle according to the size of the gap measured by the gap measurement unit.

### TECHNICAL FIELD

The present invention relates to a technology for performing work such as welding, bonding, and sealing for target members.

### BACKGROUND ART

In the past, technologies for welding two members to be welded by using a welding robot has been proposed, and technologies for calculating a moving path of a welding tool of such a welding robot in advance based on 3D (three-dimensional) CAD data or the like, checking whether the welding tool interferes with other members or the like, and changing, when it is determined that the interference will occur, the moving path has been known.

### CITATION LIST

### Patent Literature

Patent Literature 1: Japanese Patent No. 6809948

### SUMMARY

### Technical Problem

In a technology for determining a moving path for work such as welding, sealing, or bonding described in Patent Literature 1, no consideration is given to a problem that the accuracy of work may deteriorate when the actual shape of a member to be processed differs from an ideal shape thereof registered in 3D CAD data.

### Solution to Problem

A main aspect of the present invention for solving the above-described problem is a work system configured to perform work for welding or joining a plurality of target members to each other, in which the work system includes a gap measurement unit configured to measure a size of a gap that occurs between the target members, and the work system is further configured to change at least one of a position of a work nozzle and an angle of the work nozzle according to the size of the gap measured by the gap measurement unit.

Other problems to be solved and their solutions disclosed in the present application will be clarified by descriptions of embodiments according to the invention and drawings thereof.

### Advantageous Effects of Invention

According to the present invention, it is possible to provide a welding system and a welding method capable of preventing the accuracy of welding from deteriorating.

### BRIEF DESCRIPTION OF DRAWINGS

FIG. 1 shows an example of an overall configuration of a welding system 100 according to an embodiment;

FIG. 2 shows a state in which a member to be welded is measured by using the welding system 100 according to the embodiment;

FIG. 3 shows a state in which the member to be welded is welded by using the welding system 100 according to the embodiment;

FIG. 4 shows an example of a hardware configuration of a terminal 1 according to an embodiment;

FIG. 5 shows an example of a functional configuration of the terminal 1 according to the embodiment;

FIG. 6 shows an example of condition data stored in a torch position/angle condition storage unit according to an embodiment;

FIG. 7 shows an example of a flowchart of control performed by a welding system according to an embodiment;

FIG. 8 shows an example in which a gap measurement unit according to an embodiment detects a boundary line between members to be welded;

FIG. 9 shows an example of a plurality of cylindrical arcs that the gap measurement unit according to the embodiment defines around a welding path;

FIG. 10 shows an example of a welding path and an arc defined therearound when members to be welded are welded by overlap-type welding according to an embodiment;

FIG. 11 shows an example in which the gap measurement unit according to the embodiment estimates a gap size from point cloud data;

FIG. 12 shows welding that is performed when a gap size is smaller than a predetermined value in an embodiment;

FIG. 13 shows welding that is performed when a gap size is larger than the predetermined value in the embodiment;

FIG. 14 shows an example of a welding path and an arc defined therearound when members to be welded are welded by T-type welding according to an embodiment;

FIG. 15 shows an example in which the gap measurement unit according to the embodiment estimates a gap size from point cloud data;

FIG. 16 shows welding that is performed when a gap size is smaller than a predetermined value in an embodiment;

FIG. 17 shows welding that is performed when a gap size is larger than the predetermined value in the embodiment;

FIG. 18 shows an example of a welding path and an arc defined therearound when members to be welded are welded by J-type welding according to an embodiment;

FIG. 19 shows an example in which the gap measurement unit according to the embodiment estimates a gap size from point cloud data;

FIG. 20 shows welding that is performed when a gap size is smaller than a predetermined value in an embodiment; and

FIG. 21 shows welding that is performed when a gap size is larger than the predetermined value in the embodiment.

### DESCRIPTION OF EMBODIMENTS

Details of features of embodiments according to the present invention will be described one by one. The present invention includes, for example, the following features.

### Details of First Embodiment

Specific examples of a welding system 100 according to an embodiment of the present invention will be described hereinafter with reference to the drawings. Note that the present invention is not limited to these examples but is represented by the scope of the claims. Further, all modifications within the meaning and scope equivalent to those of the scope of the claims are included in the invention. The same or similar elements are assigned the same or similar reference numerals (or symbols) and the same or similar names in the following description and the accompanying drawings. Further, redundant descriptions of the same or similar elements may be omitted as appropriate in the descriptions of embodiments. Further, features shown in one embodiment can be applied to other embodiments as long as they do not contradict features in the other embodiments.

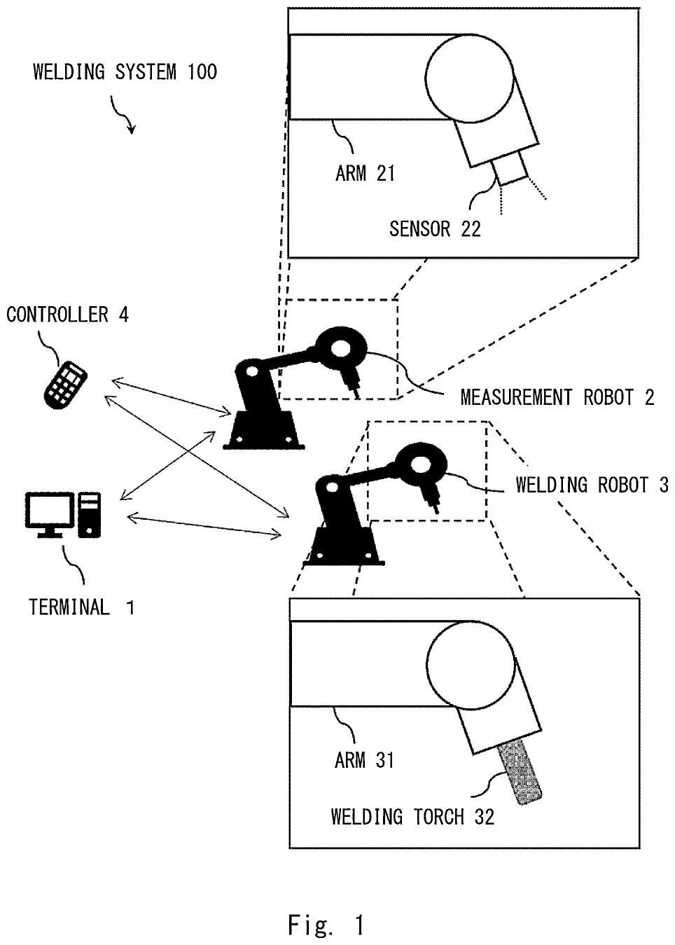

FIG. 1 shows an example of a welding system 100 according to an embodiment. As shown in FIG. 1, the welding inspection system 100 according to this embodiment includes a terminal 1, a measurement robot 2, a welding robot 3, and a controller 4. The measurement robot 2 includes at least an arm 21 and a sensor 22 mounted on the tip of the arm 21. The welding robot includes at least an arm 31 and a welding torch 32 mounted on the tip of the arm 31. Each of the terminal 1 and the controller 4 is connected to each of the measurement robot 2 and the welding robot through a wire or wirelessly so that they can communicate with each other.

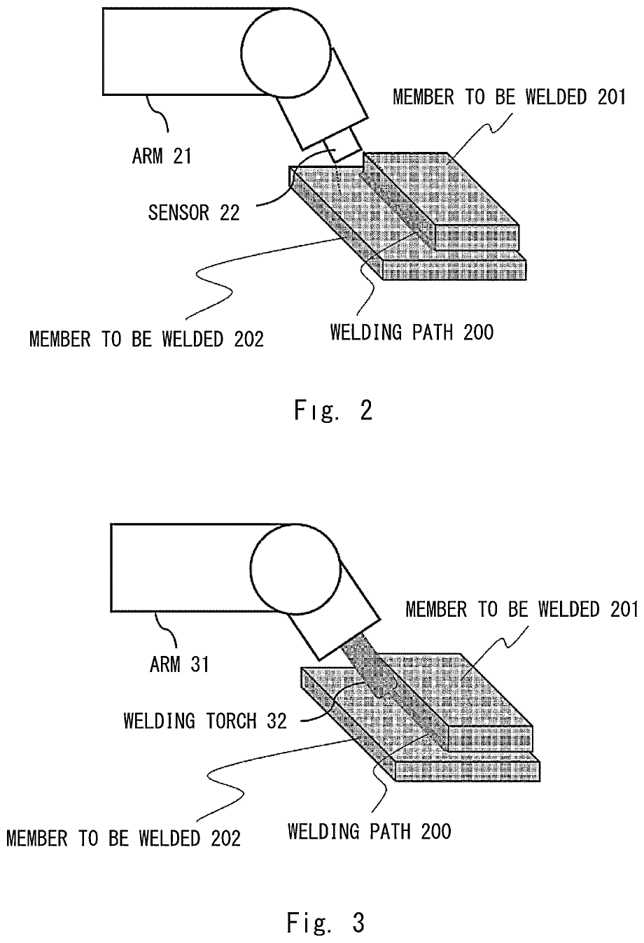

FIG. 2 shows a state in which the shape of a welding path 200 is measured by using the measurement robot 2 of the welding system 100. The welding path 200 is a predefined route for performing welding, and is typically a part where members to be welded 201 and 202, which are two members to be welded together, are close to each other. Point cloud data of the surface shapes of the two members to be welded 201 and 202 including the welding path 200 are acquired by the sensor 22 provided in the arm 21 of the measurement robot 2.

FIG. 3 shows a state in which the welding path 200 is welded by using the welding robot 3 of the welding system 100. The target position and target angle of the welding torch are determined according to the above-described shape information of the welding path 200 measured by the sensor 22 of the measurement robot 2, and the welding robot 3 controls the operation performed by the arm 31 so that the welding torch 32 is positioned at the target position and has the target angle, and thereby performs welding work.

### Terminal 1

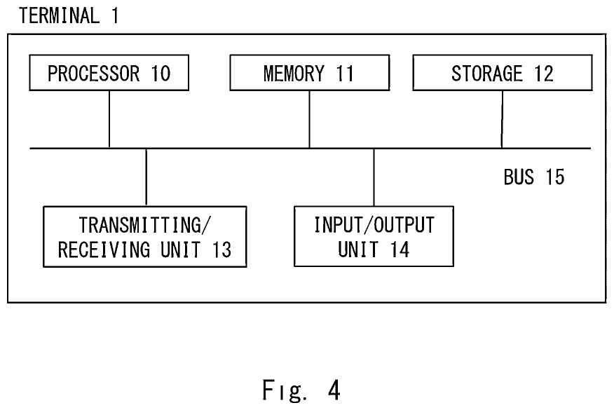

FIG. 4 shows a hardware configuration of the terminal 1. The terminal 1 may be, for example, a general-purpose computer such as a personal computer, or may be logically implemented by cloud computing. Note that the configuration shown in the drawing is just an example, and the terminal 1 may have other configurations. For example, some functions provided in a processor 10 of the terminal 1 may be implemented by an external server or another terminal.

The terminal 1 includes at least the processor 10, a memory 11, a storage 12, a transmitting/receiving unit 13, an input/output unit 14, and the like, and these components are electrically connected to each other through a bus 15.

The processor 10 controls the overall operations of the terminal 1, controls the transmission/reception of data and the like with at least the measurement robot 2 and the welding robot 3, and performs information processing or the like necessary for executing applications and an authentication process. For example, the processor 10 is a CPU (Central Processing Unit) or a GPU (Graphics Processing Unit), or is a combination of a CPU and a GPU. Further, the processor 10 performs various information processes by executing a program(s) and the like for the above-described system which is stored in the storage 12 and loaded onto the memory 11.

The memory 11 includes a main memory composed of a volatile storage device such as a DRAM (Dynamic Random Access Memory) and an auxiliary memory composed of a non-volatile storage device such as a flash memory or an HDD (Hard Disc Drive). The memory 11 is used as a work area and the like for the processor 10, and a BIOS (Basic Input/Output System) that is executed when the terminal 1 is started up and various setting information items are stored in the memory 11.

Various programs such as application programs are stored in the storage 12. A database in which data used for various processes are stored may be constructed in the storage 12.

The transmitting/receiving unit 13 connects the terminal 1 with at least the measurement robot 2 and the welding robot 3, and transmits/receives data and the like according to instructions from the processor. Note that the transmitting/receiving unit 13 is formed as a wired or wireless unit. When the transmitting/receiving unit 13 is formed as a wireless unit, it may be formed as, for example, a short-range communication interface in accordance with WiFi, Bluetooth (Registered Trademark), or BLE (Bluetooth Low Energy).

When the terminal 1 is composed of a personal computer, the input/output unit 14 is composed of an information output device (e.g., a display device) and an information input device (e.g., a keyboard and a mouse). Further, when the terminal 1 is composed of a smartphone or a tablet-type terminal, the input/output unit 14 is composed of an information input/output device such as a touch panel.

The common bus 15 is connected to each of the above-described components, and for example, address signals, data signals, and various control signals are transmitted through the bus 15.

### Measurement Robot 2

The work robot 2 according to this embodiment will be described by referring to FIGS. 1 and 2 again. As described above, the measurement robot 2 includes the arm 21 and the sensor 22. Note that the configuration shown in the drawing is just an example, and the configuration of the measurement robot 2 is not limited to this configuration.

The operation of the arm 21 is controlled by the terminal 1 based on a 3D robot coordinate system. Further, the arm 21 may also include a controller 4 which is connected to the measurement robot 2 through a wire or wirelessly, and the operation of the arm 21 may be controlled by this controller 4.

The sensor 22 performs sensing of the members to be welded 201 and 202 based on a 3D sensor coordinate system. The sensor 22 is, for example, a laser sensor which functions as a 3D scanner, and acquires 3D point group data 50 of the members to be welded 201 and 202 including the welding path 200 through the sensing. In the 3D model data 50, for example, each point data has coordinate information in the sensor coordinate system, so that it is possible to recognize the shape of an object to be inspected by a point group. Note that the sensor 22 is not limited to laser sensors, and may be, for example, an image sensor using a stereo system or the like, or may be a sensor independent of the measurement robot. That is, the sensor 22 may be any type of sensor or the like as long as it can acquire coordinate information in the 3D sensor coordinate system. Further, to give the explanation in a concrete manner, a configuration in which 3D point cloud data is used as the 3D model data 50 will be described hereinafter as an example.

Note that the robot coordinate system and the sensor coordinate system may be associated with each other by performing a predetermined calibration before performing work. Further, the arm 21 and the sensor 22 may be configured so that as a user designates a position (coordinates) based on, for example, the sensor coordinate system, the operations of the arm 21 and the sensor 22 are controlled based on their corresponding positions.

### Welding Robot 3

The welding robot 3 according to this embodiment will be described with reference to FIGS. 1 and 3. As described above, the welding robot 2 includes the arm 31 and the welding torch 32. Note that the configuration shown in the drawings is just an example, and their configuration is not limited to this configuration.

The arm 31 is controlled by the terminal 1 based on the 3D robot coordinate system. Further, the arm 31 may include a controller 4 connected to the welding robot 2 through a wire or wirelessly, and the operation of the arm 31 may be controlled by this controller 4.

The welding torch 32 performs welding work on the welding path 200, which is set to the part where the members to be welded 201 and 202 is close to each other, based on the 3D sensor coordinate system. The welding torch 32 is a tool used in a welding method using fusion welding, such as arc welding, laser welding, electron beam welding, and plasma arc welding, and outputs an arc, laser, beam or the like for melting the member to be welded therefrom and thereby welds the members to be welded 201 and 202 to each other. Note that the welding torch may be a discharge part for discharging a welding material (an adhesive) used in soldering such as brazing, or a discharge part for discharging a sealing material or an adhesive.

Note that the robot coordinate system for the measurement robot and the welding robot may be associated with the torch coordinate system by performing a predetermined calibration before performing work. Further, the arm 31 and the welding torch 32 may be configured so that as a user designates a position (coordinates) based on, for example, the torch coordinate system, the operations of the arm 31 and the welding torch 32 are controlled based on their corresponding positions.

### Function of Terminal 1

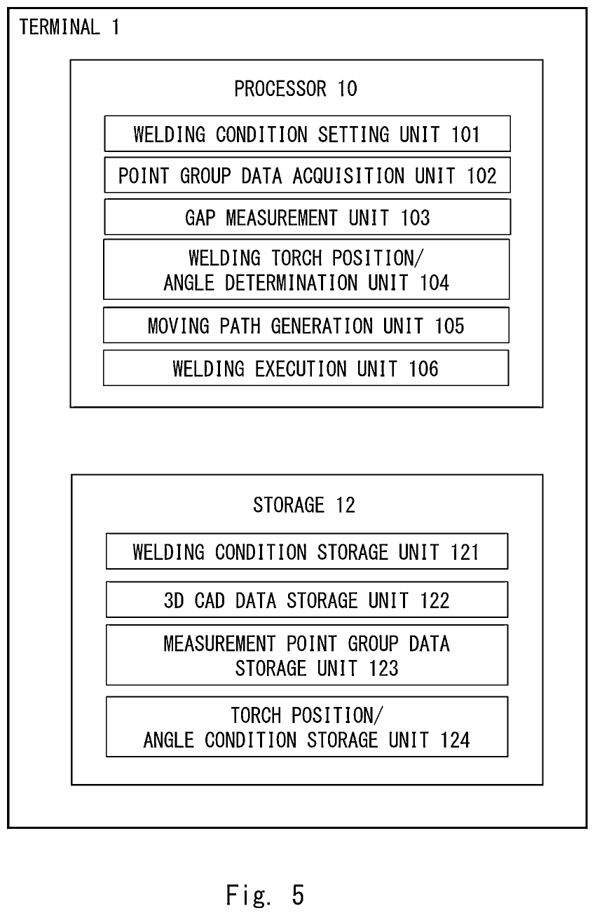

FIG. 5 is a block diagram showing an example of functions implemented in the terminal 1. In this embodiment, the processor 10 of the terminal 1 includes a welding condition setting unit 101, a point cloud data acquisition unit 102, a gap measurement unit 103, a welding torch position/angle determination unit 104, a moving path generation unit 105, and a welding execution unit 106. Further, the storage 12 of the terminal 1 includes a welding condition storage unit 121, a 3D CAD data storage unit 122, a measurement point cloud data storage unit 123, and a torch position/angle condition storage unit 124.

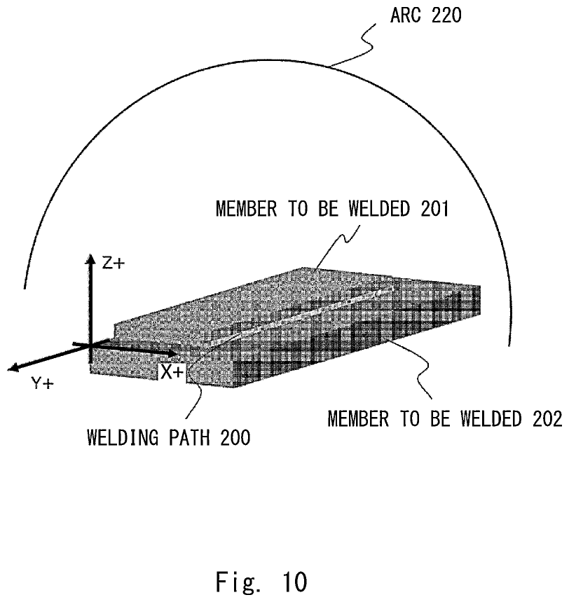

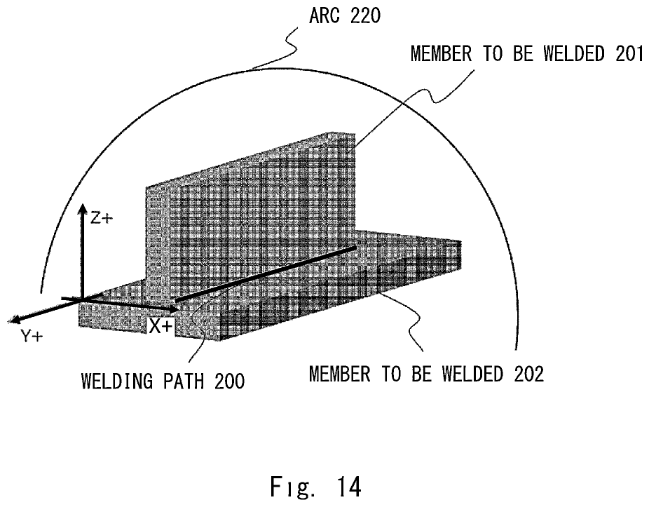

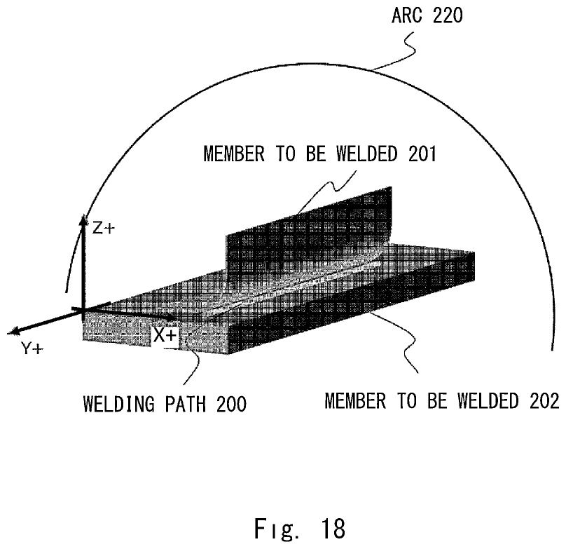

The welding condition setting unit 101 receives information about the shape type of the welding parts of the members to be welded 201 and 202 from a user through the input/output unit 14 of the terminal 1. Specifically, the user selects and inputs one of a plurality of welding shape types such as a T-type, a J-type, and an overlap type. The input shape type is stored in the welding condition storage unit 121. Note that as shown in FIG. 14, the T-type is a type in which the contact parts of two plate-like members to be welded 201 and 202 are welded in a state in which the plate-like member to be welded 201 perpendicularly stands on the surface of the other plate-like member to be welded 202 (in a state in which the two members to be welded form a T-shape in cross section). Next, as shown in FIG. 18, the J-type is a type in which a plate-like member to be welded 201, which is bent at an arbitrary angle, is welded to a member to be welded 202 with the bending part being a welding pass (the member to be welded 201 has a J-shape in cross section). Next, as shown in FIG. 10, the overlap type is a type in which an edge of a member to be welded 201 and a surface of a member to be welded 202, which are in contact with each other, are welded to each other in a state in which surfaces of the members to be welded 201 and 202 face each other, i.e., in a state in which the member to be welded 201 is overlapped with (i.e., place over) the member to be welded 202).

Further, the welding condition setting unit 101 enables the user to input (i.e., select) a welding type from linear welding in which a linear welding part is generated by continuously performing a welding operation while moving the welding torch, and point welding in which a welding operation is performed with the welding torch being at a standstill. Further, the welding condition setting unit 101 also enables the user to input the setting of a welding path 200 for CAD data of members to be welded stored in the 3D CAD data storage unit 122. Further, the welding condition setting unit 101 also enables the user to input the setting in regard to the position where gap measurement (which will be described later) is performed for the welding path 200. The input information about the welding type, the welding path 200, and the gap measurement position is stored in the welding condition storage unit 121.

The point cloud data acquisition unit 102 controls, for example, the measurement robot 2 according to an instruction from the terminal 1, and acquires 3D point cloud data 40 of the members to be welded 201 and 202 including the welding path 200 by operating the arm 21 and the sensor 22. Note that the operations of the arm 21 and the sensor 22 are set in advance so that 3D point cloud data of the welding path 200 can be acquired. The acquired 3D point cloud data is, for example, 3D coordinate information data based on the sensor coordinate system, and is stored in the measurement point cloud data storage unit 123.

The gap measurement unit 103 measures a distance (gap) between the members to be welded 201 and 202 at the set gap measurement position based on the acquired point cloud data, the information stored in the welding condition storage unit 121, and, in some cases, the information store in the 3D CAD data storage unit 122. Details of the method for measuring a gap in each shape type, i.e., each of the T-type, the J-type, and the overlap type, will be described later.

The welding torch position/angle determination unit 104 determines the position and angle of the welding torch at the gap measurement position relative to the members to be welded according to the measured size of the gap, the information about each shape type, i.e., each of the T-type, the J-type, and the overlap type, and the information stored in the torch position/angle condition storage unit 124. Further, when the size of the gap is larger than a predetermined threshold, it is determined that welding cannot be performed. Therefore, an error notification indicating that welding should not be performed is issued through the input/output unit 14, and the welding work is prohibited from being performed. Details of the method for determining the position and angle of the welding torch in each shape type, i.e., each of the T-type, the J-type, and the overlap type, will be described later.

The moving path generation unit 105 generates a moving path of the welding torch based on the determined position and angle of the welding torch at the gap measurement position. When the position and angle of the welding torch is to be determined for each of a plurality of gap measurement positions, a plurality of moving paths are generated so that the welding torch has, at each of the plurality of positions, a respective one of the determined positions and angles.

The welding execution unit 106 controls the welding robot 3 based on the generated moving path and thereby performs the welding work.

As described above, in the welding condition storage unit 121, information about the shape type such as the T-type, the J-type, and the overlap type, the welding type, the welding path 200, and the gap measurement position, of which the settings have been input by the welding condition setting unit 101, is stored. Note that the stored information is not limited to information input by the user through the welding condition setting unit 101, but may be information registered in advance in the system or information automatically determined by the system based on a predetermined rule.

In the 3D CAD data storage unit 122, the shape information about the members to be welded 201 and 202, the information about the welding path, information about the plate thicknesses of the members to be welded, information about the radii of curvatures of the bending parts of the members to be welded, and the like are stored.

In the measurement point cloud data storage unit 123, the point cloud data acquired by the point cloud data acquisition unit 102 is stored.

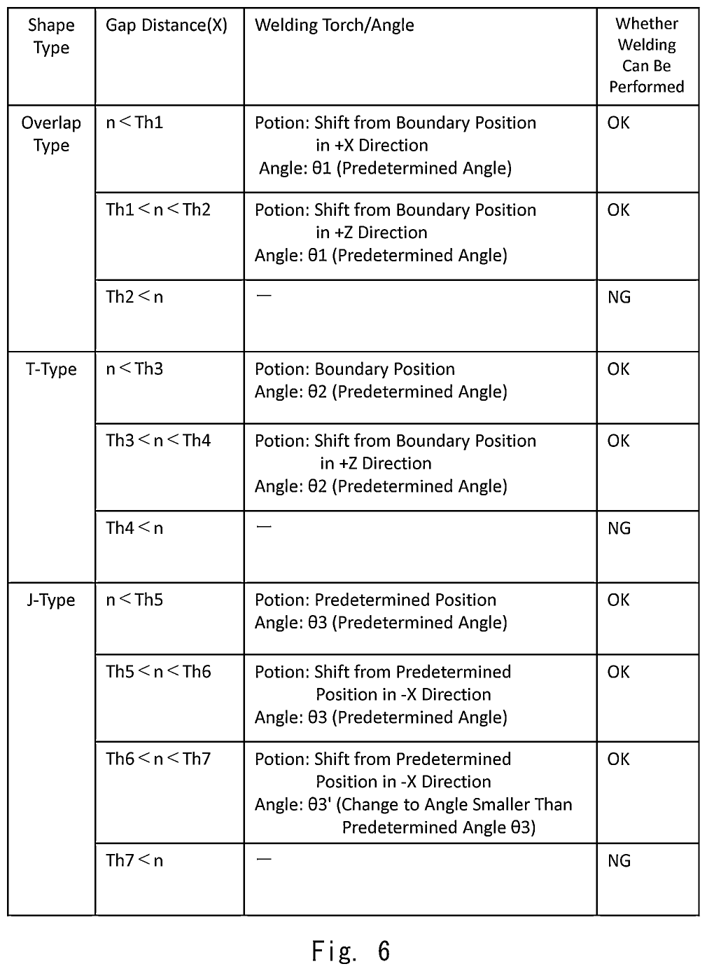

As shown in FIG. 6, in the torch position/angle condition storage unit 124, the measured size of the gap, the information about the position and angle of the welding torch corresponding to each shape type, i.e., each of the T-type, the J-type, and the overlap type, and information as to whether or not welding can be performed. In the case of the overlap type, when a gap size n is smaller than a first threshold (Th1), the position and angle of the welding torch are not changed from the predetermined position and predetermined angle (θ1), respectively. Further, when the gap size n is larger than the first threshold (Th1) and smaller than a second threshold (Th2), the position of the welding torch is shifted from the predetermined position to the positive side in the Z-direction (the torch angle is not changed from the predetermined angle). Further, when the gap size n is larger than the second threshold (Th2), it is determined that the welding cannot be performed because the gap is too large.

Next, in the case of the T-type, when the gap size n is smaller than a third threshold (Th3), the position of the welding torch is set to the position where the member boundary position is welded, and the angle of the welding torch is not changed from the predetermined angle (θ2). Further, when the gap size n is larger than the third threshold (Th3) and smaller than a fourth threshold (Th4), the torch position is shifted from the member boundary position to the positive side in the Z-direction (the torch angle is not changed from the predetermined angle (θ2)). Further, when the gap size n is larger than the fourth threshold (Th4), it is determined that the welding cannot be performed because the gap is too large.

Next, in the case of the J-type, when the gap size n is smaller than a fifth threshold (Th5), the position and angle of the welding torch are not changed from the predetermined position and the predetermined angle (θ3), respectively. When the gap size n is larger than the fifth threshold (Th5) and smaller than a sixth threshold (Th6), the torch position is shifted from the predetermined position to the negative side in the X-direction, and the torch angle is not changed from the predetermined angle. When the gap size n is larger than the sixth threshold (Th6) and smaller than a seventh threshold (Th7), the torch position is shifted from the predetermined position to the negative side in the X-direction, and the torch angle is changed from the predetermined angle (θ3) to an angle (θ3′) which is smaller than the predetermined angle (θ3) and at which the orientation of the torch is closer to the direction parallel to the member poisoned on the lower side. When the gap size n is larger than the seventh threshold (Th7), it is determined that the welding cannot be performed because the gap is too large.

### Control Flow

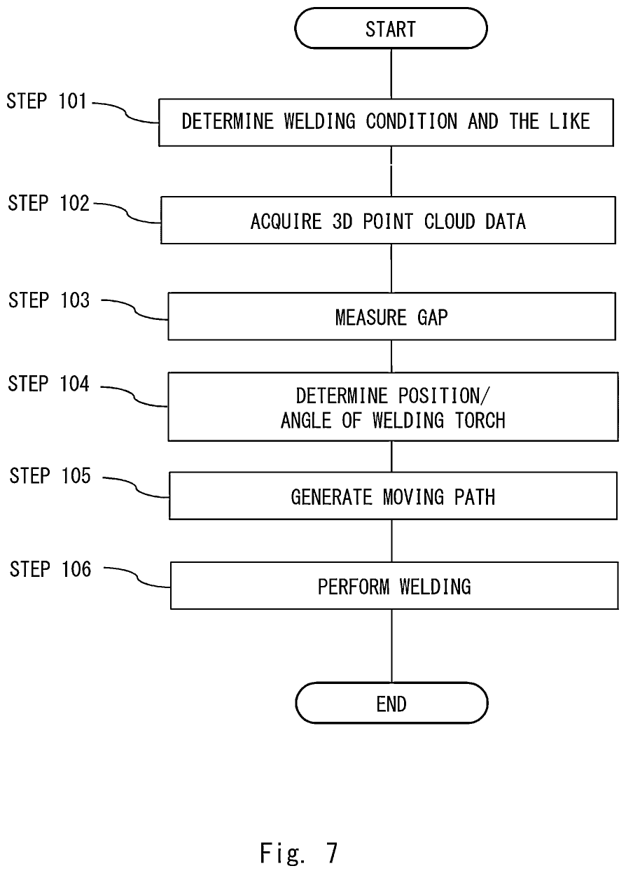

FIG. 7 shows an overall control flow of a welding system. Firstly, welding conditions and the like are determined by the welding condition setting unit 101 (Step 101). In this step, the welding condition setting unit 101 receives information about the shape type of the welding parts of the members to be welded 201 and 202 (the T-type, the J-type, the overlap type, or the like), the input welding type, the welding path 200, and the information about the gap measurement position from a user through the input/output unit 14 of the terminal 1. These information items do not necessarily have to be input by the user, and may be registered in advance in the system. In the example shown in FIG. 8, the members to be welded 201 and 202 which is to be welded in the overlap-type welding are shown. Therefore, in this case, “Overlap type” and “Linear Welding” are input as the shape type and the welding type, respectively.

Next, 3D point cloud data is acquired by the point cloud data acquisition unit 102 (Step 102). In this step, the measurement robot 2 is controlled based on the information about the welding path 200 input in the above-described step 101 or based on predefined information thereabout, and 3D point cloud data of the surface shapes of the members to be welded including the welding path 200 is thereby acquired.

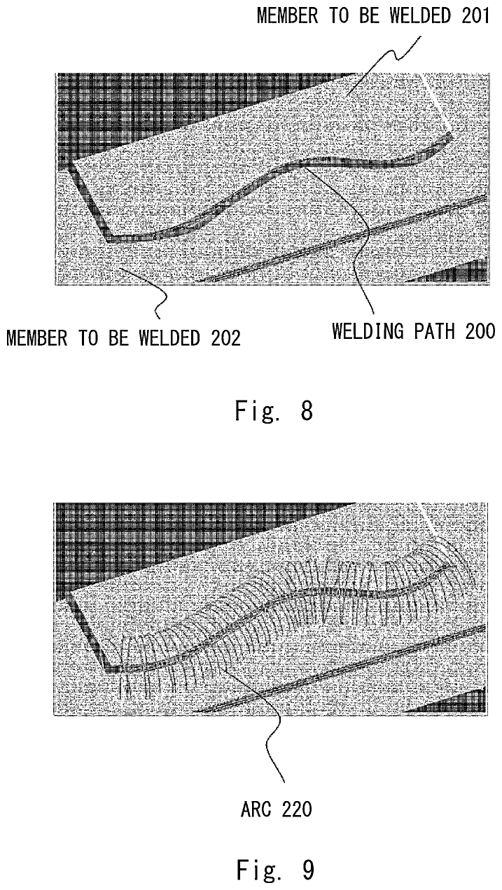

Next, the gap is measured by the gap measurement unit 103 (Step 103). In this step, the gap measurement unit 103 detects the welding path 200 based on the measured 3D point cloud data. FIG. 8 shows an example in which when the overlap-type welding is performed, a boundary line between the members to be welded 201 and 202 is detected and is detected as the welding path 200. The gap measurement unit 103 generates a plurality of arcs surrounding the welding path based on the welding path 200 and thereby generates a cylindrical space around the welding path. FIG. 9 shows an example of a plurality of cylindrical arcs which is defined around the weld path in this process. The gap measurement unit 103 extracts, on the cross-sectional plane defined by each of the arcs, 2D (two-dimensional) point cloud data inside the cylinder (inside the arc) from the 3D point cloud data acquired by the point cloud data acquisition unit 102. The gap measurement unit 103 calculates the gap size between the members to be welded 201 and 202 based on the 2D point cloud data.

Next, the welding torch position/angle determination unit 104 determines the position of the welding by the welding torch and the angle of the welding torch (Step 104). In this step, the welding torch position/angle determination unit 104 determines the position and angle of the welding torch based on the information about the position and angle of the torch corresponding to the gap size and the shape type, and the information as to whether or not the welding can be performed, both of which are stored in the torch position/angle condition storage unit 124, determines the whether or not the welding can be performed, and notifies the user of the result of determination as to whether or not the welding can be performed.

Next, a welding path is generated by the welding path generation unit 105 (Step 105). In this step, the welding path generation unit 105 generates a welding path, which is defined by the moving route and angle of the welding torch, based on the position and angle of the welding torch, which is determined for each of the cross-sectional planes defined for the plurality of arcs respectively. Note that the welding path can also be defined by the moving route which is defined only by the position of the welding torch.

Lastly, the welding is performed by the welding execution unit 106 (Step 106). In this step, the welding is performed by controlling the operations of the arm of the welding robot and the welding torch based on the welding path generated by the welding path generation unit.

FIGS. 10 to 21 show specific methods for measuring a gap and determining the welding position and angle of a welding torch for each shape type (each of the T-Type, the J-Type, and the overlap type).

### Overlap Type

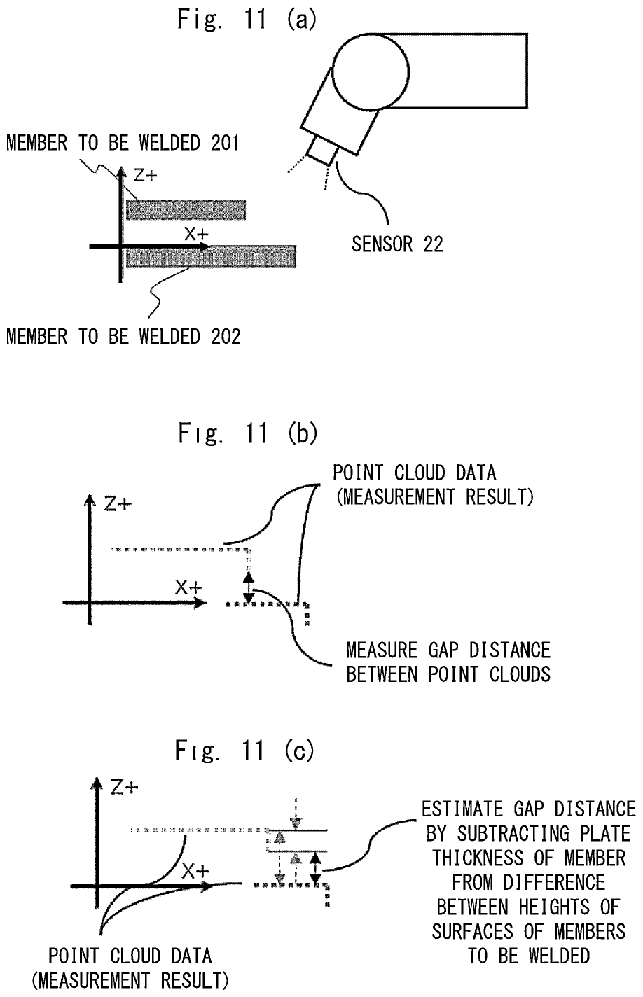

FIG. 10 shows an example of a detected welding path 200 and an arc 220 defined around the welding path when members to be welded 201 and 202 are welded by the overlap-type welding. Further, FIG. 11(a) shows a positional relationship on a cross-sectional plane defined by the arc 220 when members to be welded 201 and 202 which are to be welded by the overlap-type welding are measured. Each of FIGS. 11(b) and 11(c) shows point cloud data (2D) on the cross-sectional plane defined by the arc 220, extracted from 3D point cloud data acquired based on the positional relationship shown in FIG. 11(a). The gap measurement unit 103 acquires the gap size between the members to be welded 201 and 202 by calculating a distance between a point group indicating the lowest part (end) of the member to be welded 201 and a point group indicating the surface shape of the member to be welded 202 based on the 2D point group data like the one shown in FIG. 11(b).

Alternatively, as another method for calculating a gap size, as shown in FIG. 11(c), the gap measurement unit 103 can calculate a distance between the upper surfaces of the members to be welded 201 and 202 from a coordinate in the Z-axis direction of a point group indicating the upper surface of the member to be welded 201 and a coordinate in the Z-axis direction of a point group indicating the upper surface of the member to be welded 202, and then acquire, as the gap size, a value obtained by subtracting the plate thickness of the member to be welded 201 from the calculated distance.

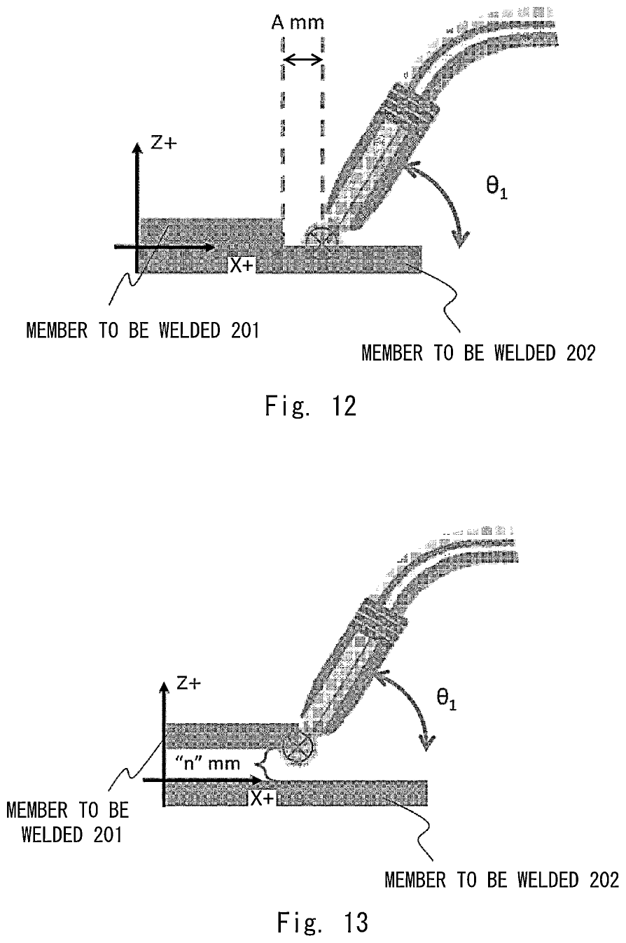

FIG. 12 shows the position of the welding by the welding torch and the angle of the welding torch when the gap size between the members is smaller than a first threshold (e.g., 0.1 to 10 millimeters). As shown in FIG. 12, when the gap size between the members is smaller than a predetermined size (e.g., 0.1 to 10 millimeters), the welding position of the welding torch is set to a position that is shifted from the member boundary position in the X-axis direction by a predetermined distance (several millimeters) in the X-axis direction, and the angle of the welding torch is determined to a predetermined angle (θ1) with respect to the member plane of the member to be welded 202.

FIG. 13 shows the position of the welding by the welding torch and the angle of the welding torch when the gap size (n millimeters) between the members is larger than the first threshold (e.g., 0.1 to 10 millimeters) and smaller than a second threshold. As shown in FIG. 13, when the gap size between members is larger than the first threshold (e.g., 0.1 to 10 millimeters) and smaller than the second threshold, the welding position of the welding torch is set to a position that is shifted from the boundary position of the members from the surface position of the member to be welded 202 in the Z-axis direction by a distance equivalent to the gap size (n millimeters) in the Z-axis direction, and the angle of the welding torch is determined to a predetermined angle (θ1) with respect to the member plane of the member to be welded 202 (i.e., the angle is not changed). By shifting the welding torch from the boundary position by a distance equivalent to the gap size (n millimeters) in the Z-axis direction as described above, it is possible to make the arc or the like discharged from the welding torch conform to the member to be welded positioned on the upper side and thereby to join it with the member to be welded positioned on the lower side.

Further, in the case where the gap size between the members is larger than the second threshold, it is likely that the welding cannot be properly performed because the gap size is too large. Therefore, as shown in FIG. 6, it is determined that the welding cannot be performed, and the user is notified that the gap size is too large or that the welding cannot be performed. Accordingly, the welding is prohibited from being performed (i.e., stopped) in the step 106.

### T-Type

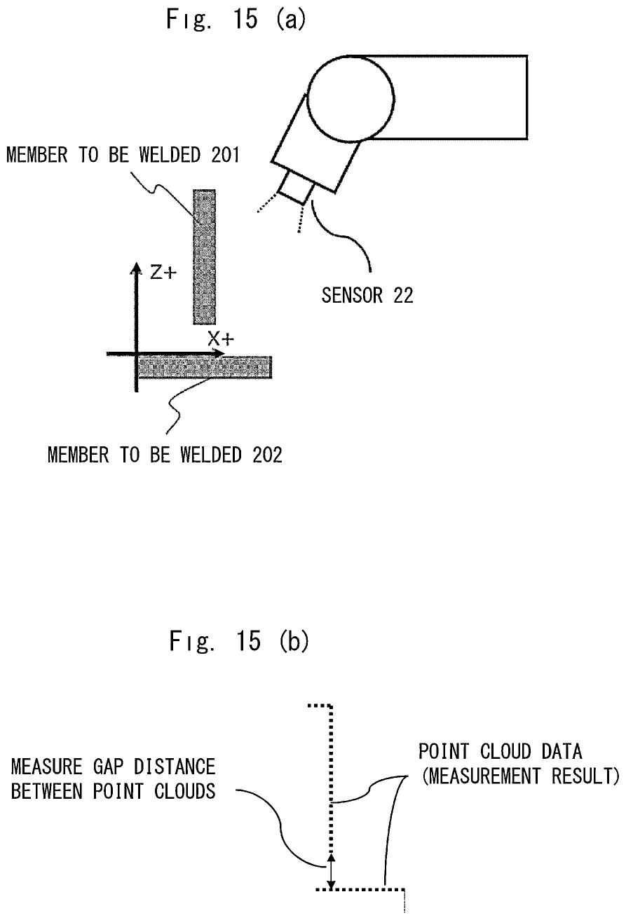

FIG. 14 shows an example of a detected welding path 200 and an arc 220 defined around the welding path when members to be welded 201 and 202 are welded by the T-type welding. Further, FIG. 15(a) shows a positional relationship on a cross-sectional plane defined by the arc 220 when members to be welded 201 and 202 which are to be welded by the T-type welding are measured. FIG. 15(b) shows point cloud data (2D) on the cross-sectional plane defined by the arc 220, extracted from 3D point cloud data acquired based on the positional relationship shown in FIG. 15(a). The gap measurement unit 103 acquires the gap size between the members to be welded 201 and 202 by calculating a distance between a point group indicating the lowest part (end) of the member to be welded 201 and a point group indicating the surface shape of the member to be welded 202 based on the 2D point group data like the one shown in FIG. 15(b).

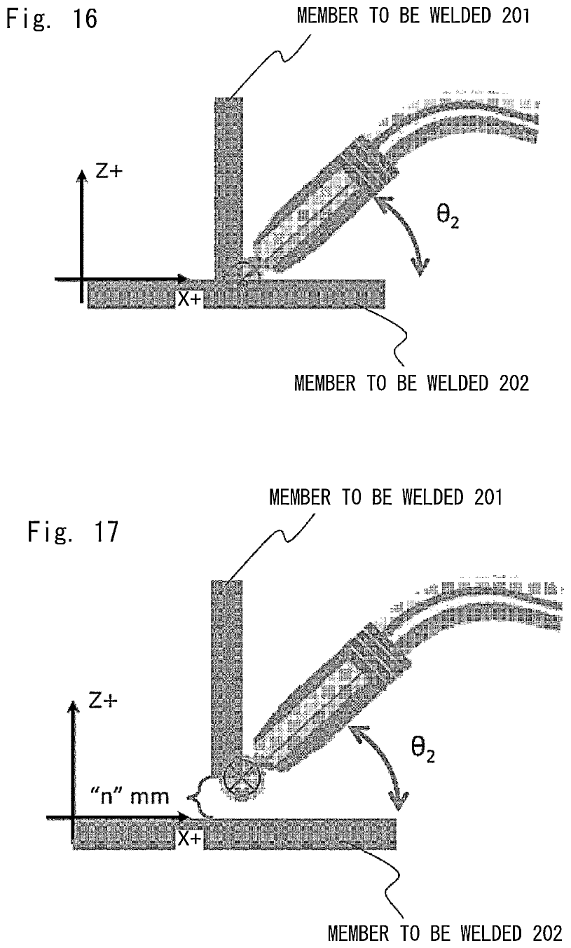

FIG. 16 shows the position of the welding by the welding torch and the angle of the welding torch when the gap size between the members is smaller than a third threshold (e.g., 0.1 to 10 millimeters). As shown in FIG. 16, when the gap size between the members is smaller than a predetermined size (e.g., 0.1 to 10 millimeters), the welding position of the welding torch is set to the boundary position of the members, and the angle of the welding torch is determined to a predetermined angle (θ2) with respect to the member plane of the member to be welded 202.

FIG. 17 shows the position of the welding by the welding torch and the angle of the welding torch when the gap size (n millimeters) between the members is larger than the third threshold (e.g., 0.1 to 10 millimeters) and smaller than a fourth threshold. As shown in FIG. 17, when the gap size between members is larger than the third threshold (e.g., 0.1 to 10 millimeters) and smaller than the fourth threshold, the welding position of the welding torch is set to a position that is shifted from the boundary position of the members from the surface position of the member to be welded 202 in the Z-axis direction by a distance equivalent to the gap size (n millimeters) in the Z-axis direction, and the angle of the welding torch is determined to a predetermined angle (θ2) with respect to the member plane of the member to be welded 202 by (i.e., the angle is not changed). By shifting the welding torch from the boundary position by a distance equivalent to the gap size (n millimeters) in the Z-axis direction as described above, it is possible to make the arc or the like discharged from the welding torch conform to the member to be welded positioned on the upper side and thereby to join it with the member to be welded positioned on the lower side.

Further, in the case where the gap size between the members is larger than the fourth threshold, it is likely that the welding cannot be properly performed because the gap size is too large. Therefore, as shown in FIG. 6, it is determined that the welding cannot be performed, and the user is notified that the gap size is too large or that the welding cannot be performed, and the welding is prohibited from being performed (i.e., stopped) in the step 106.

### J-Type

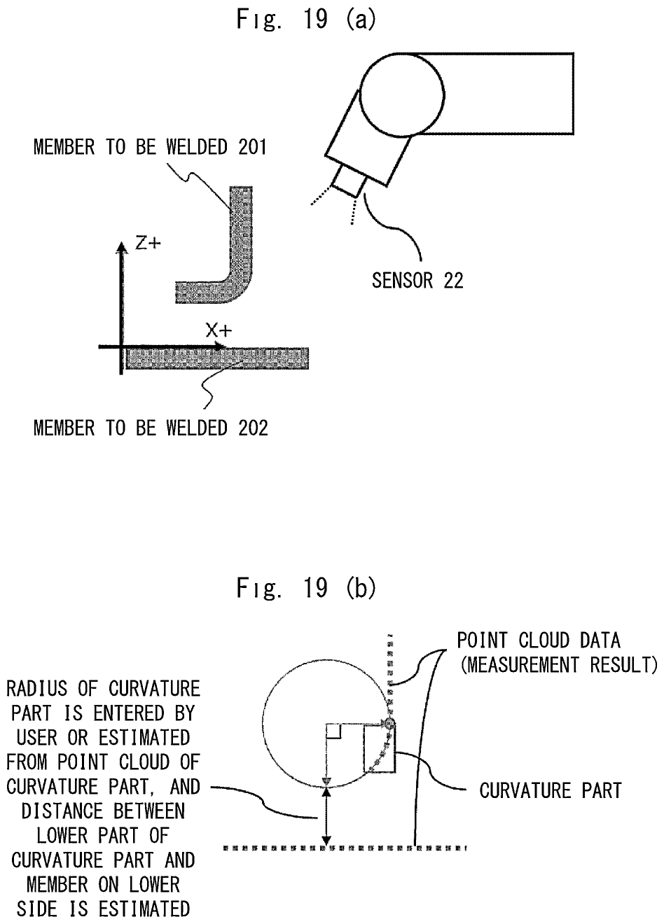

FIG. 18 shows an example of a detected welding path 200 and an arc 220 defined around the welding path when members to be welded 201 and 202 are welded by the J-type welding. Further, FIG. 19(a) shows a positional relationship on a cross-sectional plane defined by the arc 220 when members to be welded 201 and 202 which are to be welded by the J-type welding are measured. FIG. 19(b) shows point cloud data (2D) on the cross-sectional plane defined by the arc 220, extracted from 3D point cloud data acquired based on the positional relationship shown in FIG. 19(a). As shown in FIG. 19(b), the gap measurement unit 103 estimates the radius of the curvature of a curving part at which the member to be welded 201 is bent based on the point cloud data of the curbing part, or acquires the radius of the curvature based on input information entered by the user. The gap size between the lower part of the curving part (the member to be welded 202 side) and the member to be welded 202 is estimated based on the estimated or acquired radius of the curvature.

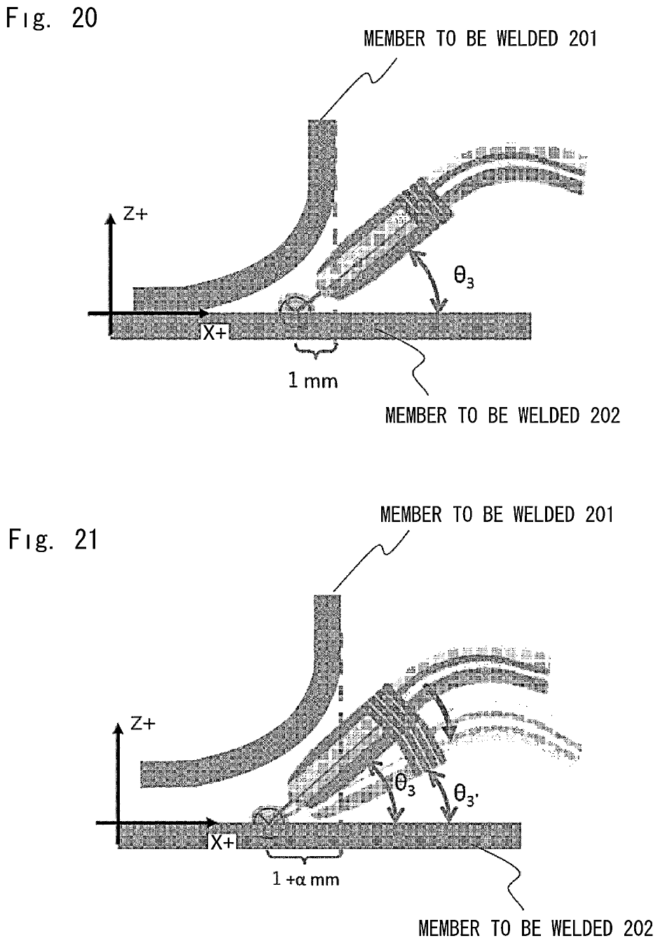

FIG. 20 shows the position of the welding by the welding torch and the angle of the welding torch when the gap size between the members is smaller than a fifth threshold (e.g., 0.1 to 10 millimeters). As shown in FIG. 20, when the gap size between the members is smaller than a predetermined size (e.g., 0.1 to 10 millimeters), the welding position of the welding torch is set to a position that is shifted from the intersection of an extension line of the side surface of the member to be welded 201 positioned on the upper side and the member to be welded 202 positioned on the lower side by a predetermined distance (e.g., 0.1 to 10 millimeters) in the X-axis negative direction, and the angle of the welding torch is determined to a predetermined angle (θ3) with respect to the member plane of the member to be welded 202. As described above, by using, as the welding position, the position shifted from the intersection of the extension line of the side surface of the member to be welded 201 positioned on the upper side and the member to be welded 202 positioned on the lower side by a predetermined distance in the X-axis negative direction, the arc discharged from the welding torch is more likely to impinge on the members to be welded positioned on the upper and lower sides, so that the members to be welded can be joined together more reliably.

FIG. 21 shows the position of the welding by the welding torch and the angle of the welding torch when the gap size (n millimeters) between the members is larger than the fifth threshold (e.g., 0.1 to 10 millimeters). When the gap size (n millimeters) between the members is larger than the fifth threshold (e.g., 1 millimeter) and smaller than a sixth threshold (e.g., 0.1 to 10 millimeters), the welding torch angle is determined to a predetermined angle (θ3) (i.e., the angle is not changed). When the gap size (n millimeters) between the members is larger than the sixth threshold (e.g., 0.1 to 10 millimeters) and smaller than a seventh threshold (e.g., 0.1 to 10 millimeters), the angle of the welding torch is reduced, and it is determined to an angle θ3′ smaller than the angle θ3 (i.e., the member to be welded positioned on the lower side). By reducing the angle of the welding torch and it is set to an angle θ3′ smaller than the angle θ3 as described above, even when the gap size between the members is large, the arc or the like discharged from the welding torch reaches the deeper side of the curving part, so that the arc discharged from the welding torch is more likely to impinge on the members to be welded positioned on the upper and lower sides, and hence the members to be welded can be joined together more reliably.

When the gap size between the members (n millimeters) is larger than the fifth threshold (e.g., 0.1 to 10 millimeters) and smaller than the seventh threshold (e.g., 0.1 to 10 millimeters), the welding position of the welding torch is set to a position that is shifted from the intersection of an extension line of the side surface of the member to be welded 201 positioned on the upper side and the member to be welded 202 positioned on the lower side in the X-axis negative direction (i.e., toward the deeper side of the curving part) by the predetermined distance +α (e.g., 0.1 to 10 millimeters). That is, the welding position is the position that is shifted toward the deeper side of the curving part from the welding position shown in FIG. 20 by the predetermined distance +α. As described above, by shifting the welding torch from the intersection of the extension line of the side surface of the member to be welded 201 positioned on the upper side and the member to be welded 202 positioned on the lower side in the X-axis negative direction (i.e., toward the deeper side of the curving part) by the predetermined distance +α, even when the gap size between the members is large, the arc or the like discharged from the welding torch reaches the deeper side of the curving part, so that the arc discharged from the welding torch is more likely to impinge on the members to be welded positioned on the upper and lower sides, and hence the members to be welded can be joined together more reliably.

Further, when the gap size between the members is larger than the seventh threshold, it is likely that the welding cannot be properly performed because the gap size is too large. Therefore, as shown in FIG. 6, it is determined that the welding cannot be performed, and the user is notified that the gap size is too large or that the welding cannot be performed. Accordingly, the welding is prohibited from being performed (i.e., stopped) in the step 106.

As described in the embodiments, by changing at least one of the position of the welding by the welding torch and the angle of the welding torch according to the distance between the members to be welded, it is possible to perform welding suitable for the situation of the welding even when a warp or a deviation occurs in the members to be welded at the time of the actual welding work, and thereby to improve the quality of the welding.

Although the embodiments have been described above, the above-described embodiments are shown just for facilitating the understanding of the present invention and are not intended to limit the scope of the present invention. The present invention may be modified or improved without departing from the scope and spirit of the invention, and the present invention includes its equivalents.

In the above-described embodiments, examples in which the present invention applied to a welding system in which welding is performed by using a robot arm have been described. However, the use of the present invention is not limited to welding. That is, the present invention can also be applied to a work system in which, for example, work for bonding boundary parts of two members to each other, such as sealing work or bonding work. In such a case, the welding torch may be replaced with a discharge part that discharges a sealing agent or an adhesive, and the work nozzle part in this specification includes a welding torch and a discharge part.

Lastly, embodiments according to the present invention will be summarized hereinafter by using drawings and corresponding descriptions.

(Claim 1)

A work system configured to perform work for welding or joining a plurality of target members to each other, wherein
the work system comprises a gap measurement unit (103) configured to measure a size of a gap that occurs between the target members, and
the work system is further configured to change at least one of a position of a work nozzle and an angle of the work nozzle according to the size of the gap measured by the gap measurement unit (103).

(Claim 2)

The work system according to claim 1, wherein when the size of the gap is larger than a first threshold, at least one of a position on the target member where work is performed by the work nozzle and the angle of the work nozzle is changed

(Claim 3)

The work system according to claim 2, wherein
when the size of the gap is larger than the first threshold and smaller than a second threshold larger than the first threshold, at least one of the position on the target member where the work is performed by the work nozzle and the angle of the work nozzle is changed, and
when the size of the gap is larger than the second threshold, the work is stopped or a user is notified that the size of the gap is large.

(Claim 4)

The work system according to any one of claims 1 to 3, wherein the work is welding work and the work nozzle is a welding torch (32).

(Claim 5)

The work system according to claim 4, further comprising a point cloud data acquisition unit (102) configured to acquire 3D (three-dimensional) point cloud data of the plurality of target members, wherein
the gap measurement unit (103) detects a welding path (200) at which welding is performed based on the acquired 3D point cloud data, and measures the size of the gap from 2D (two-dimensional) point cloud data on a cross section of the welding path (200).

(Claim 6)

The work system according to claim 4 or 5, wherein
the plurality of target members include a first member and a second member, and
when the first and second members are welded to each other in a state in which surfaces of the first and second members overlap each other, and when a size of a gap between the first and second members is larger than the first threshold and smaller than the second threshold, a position of the welding torch (32) is set to a position that is shifted toward the first member relative to the second member from the position of the welding torch (32) at the time when the size of the gap is smaller than the first threshold.

(Claim 7)

The work system according to claim 4 or 5, wherein
the plurality of target members include a first member and a second member, and
when the first and second members are welded to each other in a state in which the first member perpendicularly stands on the second member, and when a size of a gap between the first and second members is larger than the first threshold and smaller than the second threshold, a position of the welding torch (32) is set to a position that is shifted toward the first member relative to the second member from the position of the welding torch (32) at the time when the size of the gap is smaller than the first threshold.

(Claim 8)

The work system according to claim 4 or 5, wherein
the plurality of target members include a first member and a second member,
the first member comprises a bending part, and
when the bending part is welded to the second member, and when a size of a gap between the first and second members is larger than the first threshold and smaller than the second threshold, a position of the welding torch (32) is set to a position at which a plane of the second member is shifted toward the first member relative to the position of the welding torch (32) at the time when the size of the gap is smaller than the first threshold.

(Claim 9)

The work system according to claim 4 or 5, wherein
the plurality of target members include a first member and a second member,
the first member comprises a bending part, and
when the bending part is welded to the second member, and when a size of a gap between the first and second members is larger than the first threshold and smaller than the second threshold, an angle of the welding torch (32) with respect to the second member is set to an angle smaller than an angle at the time when the size of the gap is smaller than the first threshold.

(Claim 10)

A work method using a system configured to perform work for welding or joining a plurality of target members to each other, comprising:
a gap measurement process of measuring a size of a gap that occurs between the target members; and
a process of changing at least one of a position of a work nozzle and an angle of the work nozzle according to the size of the gap measured in the gap measurement process.

### REFERENCE SIGNS LIST

1 Terminal
2 Measurement Robot
3 Welding Robot
4 Controller
10 Processor
11 Memory
12 Storage
13 Transmitting/Receiving Unit
14 Input/Output Unit
15 Bus
21,31 Arm
22 Sensor
32 Welding Torch
200 Welding Path
201, 202 Member To Be Welded
220 Arc
100 Welding System
101 Welding Condition Setting Unit
102 Point Group Data Acquisition Unit
103 Gap Measurement Unit
104 Welding Torch Position/Angle Determination Unit
105 Moving Path Generation Unit
106 Welding Execution Unit
121 Welding Condition Storage Unit
122 3D Cad Data Storage Unit
123 Measurement Point Group Data Storage Unit
124 Torch Position/Angle Condition Storage Unit

1. A work system configured to perform work for welding or joining a plurality of target members to each other, wherein
the work system comprises a gap measurement unit configured to measure a size of a gap that occurs between the target members, and
the work system is further configured to change at least one of a position of a work nozzle and an angle of the work nozzle according to the size of the gap measured by the gap measurement unit.

2. The work system according to claim 1, wherein when the size of the gap is larger than a first threshold, at least one of a position on the target member where work is performed by the work nozzle and the angle of the work nozzle is changed.

3. The work system according to claim 2, wherein
when the size of the gap is larger than the first threshold and smaller than a second threshold larger than the first threshold, at least one of the position on the target member where the work is performed by the work nozzle and the angle of the work nozzle is changed, and
when the size of the gap is larger than the second threshold, the work is stopped or a user is notified that the size of the gap is large.

4. The work system according to claim 1, wherein the work is welding work and the work nozzle is a welding torch.

5. The work system according to claim 4, further comprising a point cloud data acquisition unit configured to acquire 3D (three-dimensional) point cloud data of the plurality of target members, wherein
the gap measurement unit detects a welding path at which welding is performed based on the acquired 3D point cloud data, and measures the size of the gap from 2D (two-dimensional) point cloud data on a cross section of the welding path.

6. The work system according to claim 4, wherein
the plurality of target members include a first member and a second member, and
when the first and second members are welded to each other in a state in which surfaces of the first and second members overlap each other, and when a size of a gap between the first and second members is larger than the first threshold and smaller than the second threshold, a position of the welding torch is set to a position that is shifted toward the first member relative to the second member from the position of the welding torch at the time when the size of the gap is smaller than the first threshold.

7. The work system according to claim 4, wherein
the plurality of target members include a first member and a second member, and
when the first and second members are welded to each other in a state in which the first member perpendicularly stands on the second member, and when a size of a gap between the first and second members is larger than the first threshold and smaller than the second threshold, a position of the welding torch is set to a position that is shifted toward the first member relative to the second member from the position of the welding torch at the time when the size of the gap is smaller than the first threshold.

8. The work system according to claim 4, wherein
the plurality of target members include a first member and a second member,
the first member comprises a bending part, and
when the bending part is welded to the second member, and when a size of a gap between the first and second members is larger than the first threshold and smaller than the second threshold, a position of the welding torch is set to a position at which a plane of the second member is shifted toward the first member relative to the position of the welding torch at the time when the size of the gap is smaller than the first threshold.

9. The work system according to claim 4, wherein
the plurality of target members include a first member and a second member,
the first member comprises a bending part, and
when the bending part is welded to the second member, and when a size of a gap between the first and second members is larger than the first threshold and smaller than the second threshold, an angle of the welding torch with respect to the second member is set to an angle smaller than an angle at the time when the size of the gap is smaller than the first threshold.

10. A work method using a system configured to perform work for welding or joining a plurality of target members to each other, comprising:
a gap measurement process of measuring a size of a gap that occurs between the target members; and
a process of changing at least one of a position of a work nozzle and an angle of the work nozzle according to the size of the gap measured in the gap measurement process.
